(19) United States
(12) Patent Application Publication
(10) Pub. No.: US 2006/0228639 A1
(43) Pub. Date: Oct. 12, 2006

(54) Toner containing low melt wax stripping enhancing agent

(75) Inventors: Eugene F. Young, Rochester, NY (US); David H. Pan, Rochester, NY (US); Robert S. Pawlik, Webster, NY (US); Robert R. Tuchrelo, Williamson, NY (US); Billy T. Stojanovski, Webster, NY (US); William H. Hollenbaugh JR., Rochester, NY (US); Michael L. Grande, Palmyra, NY (US); Hui Chang, Pittsford, NY (US); Mark E. Mang, Rochester, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/103,502

(22) Filed: Apr. 12, 2005

(51) Int. Cl. G03G 9/08

(52) U.S. Cl. 430/108.4; 430/108.8; 430/124

(57) ABSTRACT

Toners including a low melt wax and a carnauba wax are described. The toners include at least one binder, at least one colorant, at least one wax having a melting point of 135° C. or less, and a compatibilizer wax (e.g., carnauba wax). The low melt wax is preferably polyethylene wax. Images may be formed with the toners in an image forming process including steps of depositing the toner onto a latent image of an imaging member to form a toner image, transferring the toner image to an image receiving substrate, and fusing the toner image. During the fusing, the at least one wax and the compatibilizer wax exude from the toner, forming a stripping enhancing layer upon the toner image. Thus, fuser roll stripping performance is enhanced.

### BACKGROUND

Described herein are toners containing both a low melt wax and carnauba wax, and more in particular toners comprised of at least one binder, at least one colorant, a wax having a melting point of 135° C. or less, and carnauba wax. Also described are developers containing such toner and image formation processes using such toner.

Toners are known that include therein a high melting polypropylene wax, e.g., a polypropylene wax such as POLYWAX 550P or 660P, having melting points of 140° C. or more. Such waxes have performed adequately in fuser roll stripping and offset when fused using a polytetrafluoroethylene (e.g., TEFLON) on metal fuser roll.

However, fuser rolls of polytetrafluoroethylene on silicone have been found advantageous as able to handle a much wider range of paper weights and smoothness as compared to a polytetrafluoroethylene on metal fuser roll. Unfortunately, when a polytetrafluoroethylene on silicone fuser roll is used with the high melting polypropylene wax containing toners, the image receiving substrate (e.g., paper) does not easily strip off the fuser roll. This causes the paper to collide with the stripper fingers and causes streaks in the prints due to the abrasion from the stripper fingers. This results in unacceptable print quality, especially solid area. The stripper finger marks are extremely bad at preferable low fusing temperatures, e.g., 100 to 200° C., but become better (i.e., fewer present) at higher fusing temperatures, i.e., >215° C. Running the fuser temperature at such high temperatures, though, is itself undesirable as it requires a high amount of energy, shortens the fuser roll life and significantly reduces fusing latitude. Further, these higher fusing temperatures tend to cause unacceptable solid area mottles and paper curl.

What is desired is a toner that has acceptable fuser roll stripping performance, particularly when used with a polytetrafluoroethylene coated fuser roll operating in the 100 to 200° C. fusing temperature range.

### SUMMARY

In embodiments, described herein are toners comprising at least one binder, at least one colorant, at least one wax having a melting point of 135° C. or less, and at least one compatibilizer wax.

In further embodiments, described are toners wherein the at least one wax is a polyolefin wax, preferably a polyethylene wax.

In further embodiments, described are developers comprised of at least one carrier in admixture with a toner comprising at least one binder, at least one colorant, at least one wax having a melting point of 135° C. or less, and a compatibilizer wax.

In still further embodiments, described is an image forming process, comprising depositing toner onto a latent image of an imaging member to form a toner image, transferring the toner image to an image receiving substrate, and fusing the toner image, wherein the toner comprises at least one binder, at least one colorant, at least one wax having a melting point of 135° C. or less, and a compatibilizer wax, and wherein the at least one wax and the compatibilizer wax exude from the toner during the fusing, forming a stripping enhancing layer upon the toner image. Preferably, fusing is conducted at a temperature of from about 100° C. to about 200° C.

### BRIEF DESCRIPTION OF THE DRAWINGS

FIG. 1 shows the signal-time plot of two test prints from the Comparative Example 1 toner at a fusing temperature of 216° C., a process speed of 362 mm/s and a heating time on fixing of about 20 ms.

FIG. 2 summarizes the stripping force data for Example toners 1-5 compared to the toner of Comparative Example 1 at three fusing temperatures (188, 199 and 210° C.) and a process speed of 362 mm/s.

FIG. 3 shows the calculated force integral (volt-sec) vs. area coverage (%) for the Example 6-11 and Comparative Example 2 toners at a fusing temperature of about 193° C. and a process speed of about 600 mm/s.

### DETAILED DESCRIPTION OF EMBODIMENTS

In embodiments, the toner herein is comprised of at least one binder, at least one colorant, a wax having a melting point of 135° C. or less, and a compatibilizer wax.

As the at least one toner binder, any suitable toner binder or toner binder mixture may be used. Most preferably, the toner binder is one having a molecular weight and/or glass transition temperature permitting the toner to be fused at temperatures of from 100° to 200° C.

As example binder materials, mention may be made of thermoplastic binder resins such as, for example, polystyrenes, styrene-acrylics, styrene-methacrylics, polyesters, epoxies, acrylics, urethanes and copolymers and mixtures thereof.

In a preferred embodiment, the binder is a polyester binder. For example, a polyester resin derived from a dicarboxylic acid and a diphenol is preferred. Example resins are illustrated in, for example, U.S. Pat. No. 3,590,000, the disclosure of which is totally incorporated herein by reference. Also, polyester resins obtained from the reaction of bisphenol A and propylene oxide or propylene carbonate (a propoxylated bisphenol A polymer or copolymer), and in particular including such polyesters followed by the reaction of the resulting product with a carboxylic acid, e.g., fumaric acid, isophthalic acid and/or trimellitic acid (reference U.S. Pat. No. 5,227,460, the disclosure of which is totally incorporated herein by reference). DIACRON, a polyester commercially available from Mitsubishi Rayon, may suitably be used, such polyester being a propoxylated bisphenol A based saturated polyester having a glass transition temperature of from about 55° C. to about 75° C. Other commercially available polyester resins may also be used, for example such as SPAR II (a linear propoxylated bisphenol A fumarate resin) available from Resana S/A Industrias Quimicas.

The binder resin may be linear, branched, or may include crosslinking therein. As described in U.S. Pat. No. 5,227,460, a polyester resin may include both linear and crosslinked portions. Crosslinked polyesters generally exhibit higher viscoelasticity, which can assist in stripping performance. However, too much crosslinking may result in too high viscoelasticity, which may lead to degraded fix performance. Besides crosslinked polyester resins, other binder resins may include crosslinked styrene acrylates.

In preferred embodiments, the toner binder comprises at least 75% by weight of the toner, preferably from about 85 to about 95% by weight of the toner.

As the at least one colorant, any colorant, including pigments, dyes or mixtures thereof, may be used without restriction. Various known suitable colorants, such as dyes, pigments, and mixtures thereof, may be included in the toner in an effective amount of, for example, about 1 to about 15% by weight of the toner, and preferably in an amount of about 1 to about 10% by weight. As examples of suitable colorants, which is not intended to be an exhaustive list, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Specific examples of pigments include phthalocyanine HELIOGEN BLUE L6900, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), and Lithol Fast Scarlet L4300 (BASF).

As the low melt wax having a melting point of 135° C. or less, waxes and wax mixtures that impart stripping enhancing characteristics to a toner may be used. Preferred examples include polyolefin waxes such as polyethylene and polypropylene waxes. Most preferably, a polyolefin wax having a melting point of less than 110° C. may be used. In a preferred embodiment, the polyolefin wax is a polyethylene wax. Such a wax is commercially available as POLYWAX 850 or POLYWAX 725 from Baker Petrolite. POLYWAX 850 is a polyethylene wax having a melting point of about 107° C. and POLYWAX 725 is a polyethylene wax having a melting point of about 104° C.

In embodiments, the low melt wax(es) may have a melting point of 135° C. or less, or 120° C. or less.

Additional examples of low melt waxes having a melting point of 135° C. or less that may be used include POLYWAX 655 (melting point of 99° C.), POLYWAX 600 (melting point of 94° C.), and POLYWAX 500 (melting point of 88° C.), each available from Baker Petrolite; waxes from the Baker Petrolite propylene/hexene copolymer series, including X-10011 (melting point of 120° C.), X-10018 (melting point of 94° C.) and X-10019 (melting point of 104° C.); waxes from the Baker Petrolite ethylene/propylene copolymer series, including EP-700 (melting point of 94° C.), EP-1104 (melting point of 100° C.), EP-1100 (melting point of 110° C.) and EP-1200 (melting point of 112° C.); silicone waxes; aliphatic amide waxes, including oleic amide, erucic amide, ricinolic amide and stearic amide; and mineral or petroleum waxes, including montan wax, ozocerite, ceresine, paraffin wax, microcrystalline wax, and Fishcher-Tropsch.

The low melt wax is preferably present in an amount of from about 1 to about 8% by weight of the toner, more preferably in an amount of from about 1 to about 5% by weight of the toner.

As the compatibilizer wax, waxes and wax mixtures that function as a compatibilizer in permitting the low melt wax to form substantially uniformly distributed wax domains throughout the toner binder when the toner is made via melt mixing of the toner components are preferably used. Preferred examples of suitable waxes are carnauba wax, Baker Petrolite oxidized polyethylenes such as C-8500 (melting point of 95° C.), C-7500 (melting point of 97° C.), C-2020 (melting point of 116° C.), C-9500 (melting point of 94° C.), and C-1040 (melting point of 106° C.); Baker Petrolite oxidized polymers such as CARDIS 314 (melting point of 87° C.), PETRONAUBA C (melting point of 93° C.), CARDIS 36 (melting point of 92° C.), and CARDIS 320 (melting point of 91° C.); Baker Petrolite UNICID 350 (melting point of 115° C.) or UNICID 425 (melting point of 94° C.); Baker Petrolite UNILIN 425 (melting point of 91° C.), UNILIN 550 (melting point of 99° C.), or UNILIN 700 (melting point of 106° C.); Baker Petrolite 420 (melting point of 91° C.), UNITHOX 450 (melting point of 91° C.), UNITHOX 480 (melting point of 86° C.), UNITHOX 520 (melting point of 99° C.), UNITHOX 550 (melting point of 99° C.), UNITHOX 720 (melting point of 106° C.), or UNITHOX 750 (melting point of 106° C.); Baker Petrolite epoxide functionalized polymers such as X-10030 (melting point of 95° C.) and X-10039 (melting point of 104° C.); Baker Petrolite maleic functional polymers such as X-10016 (melting point of 118° C.); vegetable waxes, including rice wax, candelilla wax, and haze wax; and animal waxes, including bees wax. The compatibilizer wax is preferably present in the toner in an amount of from about 0.5 to about 5% by weight, preferably from about 0.5 to about 3% by weight, of the toner.

In a most preferred embodiment, the compatibilizer wax is carnauba wax. Carnauba wax is a naturally occurring crystalline wax. The structure of carnauba wax includes normal saturated fatty acids and normal saturated primary alcohols (myricyl ceretate and myricyl alcohol—C₂₉H₅₉CH₂OH). It typically has a melting point of about 84° C. In a preferred embodiment, the carnauba wax is included in the toner in an amount of from about 0.5 to about 5% by weight, preferably from about 0.5 to about 3% by weight, of the toner. Further, it is preferred that the ratio of the low melt wax to the carnauba wax ranges from about 1:2 to about 10:1, preferably from about 1:2 to about 6:1.

The carnauba wax appears to provide at least two beneficial attributes to the toner. First, the carnauba wax appears to enhance the fuser roll stripping enhancing function of the low melt wax, including low melt polyolefin waxes, regardless of the method used to prepare the toner. Second, the carnauba wax appears to also function as a compatibilizer, permitting the low melt wax to form substantially uniformly distributed wax domains throughout the toner binder when the toner is made via melt mixing of the toner components.

In toners prepared via a melt mixing and pulverization method, also known as a physical preparation method, the toner components are mixed/blended at an elevated temperature to form a toner mass that is subsequently cooled and pulverized to form toner particles. Various problems have been found to be associated with the inclusion of low melt waxes therein, and specifically low melt polyolefin waxes. For example, the low melt wax does not suitably disperse in the toner resin binder. As a result, free wax particles may be released during the pulverizing/jetting, or micronization of the toner in, for example, a fluid energy mill, and the pulverization rate may be low. The poor dispersion of low melt wax in the toner resin and the resulting loss of wax may impair the release function from the fuser roll it is designed for. Scratch marks, for example, on xerographic developed toner solid areas caused by stripper fingers can result from poor release. Furthermore, the free wax remaining in the developer may build up on the detone roll present in the xerographic apparatus causing a hardware failure.

Moreover, the release of wax particles may result from the poor dispersion of wax generated during the toner mechanical blending step. The low melt waxes become a separate molten phase during melt mixing, and the difference in viscosity between the wax and the resin may be orders of magnitude apart. This causes difficulty in reducing the wax phase domain size, and thus poor wax dispersion. A more fundamental reason for poor wax dispersion is the inherent thermodynamic incompatibility between polymers. The Flory-Huggins interaction parameter between the toner resin and the wax is usually positive (repulsive) and large so that the interfacial energy remains high and in favor of phase separation into large domains to reduce the interfacial area.

For toners prepared by melt mixing of the toner components, the compatibilizer wax such as carnauba wax acts as a compatibilizer to overcome the inherent incompatibility between different polymers, and, more specifically, between the toner binder resin and the low melt wax, thus broadening the processing temperature latitude and enabling the toner to be prepared with the low melt wax domains substantially uniformly dispersed therein. The above improvement in thermodynamic compatibility will also provide for a more stable dispersion of the wax in the host resin, and substantial phase separation over time can be minimized.

The toner of embodiments herein may also include additional conventional toner additives therein, without limitation. For example, charge enhancing additives or charge control agents may be included, if desired or necessary. Of course, conventional external additives, e.g., silica, titania, zinc stearate and the like, may also be included as desired or necessary.

In embodiments, toner particles herein may have any suitable size. Preferably, the toner particles have a relatively small size, for example having a volume average particle diameter of from about 2 to about 15 microns, preferably from about 3 to about 9 microns.

Toners of embodiments may be made by the physical melt mixing procedure such as discussed above, or may be made by chemical processes as well. Example known chemical processes include suspension polymerization and emulsion aggregation processes, in which the binder is prepared and the toner particles are grown in solution. In such processes, the components are emulsified and the toner particles grown (agglomerated) from such emulsification. While the dispersions used in the chemical build up processes permit the low melt wax to be adequately, and substantially uniformly, dispersed in the toner particles without the use of a compatibilizer, the compatibilizer wax such as carnauba wax is still preferably included for the additional stripping enhancing benefits.

Both the physical and chemical processes for making toners are well known in the art, and additional description herein of such processes is not necessary.

The toner particles may be used in forming a developer by admixing with one or more carrier particles. Any carrier particle may be used without limitation. Carrier particles that can be selected for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Additionally, there can be selected as carrier particles nickel berry carriers, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326, the disclosures of which are hereby totally incorporated herein by reference.

The effects of the inclusion of a substantially uniformly dispersed low melt wax in a toner with respect to image formation using the toner is now further detailed.

In an image forming process, an image forming device is used to form a print, typically a copy of an original image. An image forming device imaging member (e.g., photoreceptive member), typically including, for example, a photoconductive insulating layer on a conductive layer, is imaged by first uniformly electrostatically charging the surface of the photoconductive insulating layer. The member is then exposed to a pattern of activating electromagnetic radiation, for example light, which selectively dissipates the charge in the illuminated areas of the photoconductive insulating layer while leaving behind an electrostatic latent image in the non-illuminated areas. This electrostatic latent image may then be developed to form a visible image by depositing the toner particles, for example from a developer composition, on the surface of the photoconductive insulating layer. The resulting visible toner image can be transferred to a suitable image receiving substrate such as paper and the like.

To fix the toner to the image receiving substrate, such as a sheet of paper or transparency, hot roll fixing is commonly used. In this method, the image receiving substrate with the toner image thereon is transported between a heated fuser roll and a pressure roll with the image face contacting the fuser roll. Upon contact with the heated fuser roll, the toner melts and adheres to the image receiving medium, forming a fixed image. This fixing system is very advantageous in heat transfer efficiency and is especially suited for high speed electrophotographic processes.

Fixing performance of the toner can be characterized as a function of temperature. The lowest temperature at which the toner adheres to the support medium is referred to as the Cold Offset Temperature (COT), and the maximum temperature at which the toner does not adhere to the fuser roll is referred to as the Hot Offset Temperature (HOT). When the fuser temperature exceeds HOT, some of the molten toner adheres to the fuser roll during fixing and is transferred to subsequent substrates containing developed images resulting, for example, in blurred images. This undesirable phenomenon is known as offsetting. Between the COT and HOT of the toner is the Minimum Fix Temperature (MFT), which is the minimum temperature at which acceptable adhesion of the toner to the image receiving substrate occurs, as determined by, for example, a creasing test. The difference between MFT and HOT is referred to as the fusing latitude.

As was noted above, it is preferable to use a polytetrafluoroethylene (e.g., TEFLON) coated roll, preferably a TEFLON coated silicone roll, as the fuser roll in fusing the toner image. Such a fuser roll is able to handle a wide variety of paper weights and smoothnesses. Typically, such fuser rolls are used with little to no release agent material being provided on the external surface thereof. However, some fuser rolls may still have small amounts of release agent, e.g., silicone oil, applied thereto. Regardless, it is necessary for the toner to possess an ability to strip from the fuser roll surface. Poor stripping characteristics can cause unacceptable stripper finger marks on the prints, and can also cause paper jamming in the device. Such problems were experienced with the use of high melt polypropylene wax containing toners, as discussed above.

The inclusion of small and substantially uniformly distributed low melt wax domains along with compatibilizer wax, in place of a conventional high melt polypropylene wax, overcomes this problem. During the fusing procedure, as the toner is heated as it nears the fusing station, the low melt wax and carnauba wax begin to exude from the toner particles, a process referred to as wax blooming. The use of the low melt wax and compatibilizer wax is advantageous in this regard in that the low melting points (less than 135° C.) of these waxes enables them to be readily and rapidly exuded from the toner at a lower temperature.

As the image continues to approach the fuser roll/pressure roll contact point in the fusing station, the toner continues to be heated. The toner itself melts to flow into and over the paper, while the low melt wax and carnauba wax exuded therefrom forms a thin film on the surface of the toner image facing the fuser roll. In preferred embodiments, substantially all of the toner image has a wax stripping enhancing layer comprised of the low melt wax and compatibilizer wax formed thereover, at least prior to contact at the fuser roll/pressure roll point.

A wax stripping enhancing layer is thus formed on the surface of the toner image. It is believed that this wax stripping enhancing layer has a thickness of from about 1 to about 20 nm, preferably from about 2 to about 10 nm, depending on the amount of low melt polyolefin wax included in the toner. Wax blooming to form this stripping enhancing layer is evidenced by direct measurements of chemical composition of fused images by using x-ray photoelectron spectroscopy (XPS), which can analyze the chemical composition of the top 5 nm of a layer.

In theory, as the image is processed through the fusing station, the stripping enhancing wax layer splits in proportion at the point of separation between the molten image and the fuser roll surface. A fraction of the wax layer may remain on the molten image surface, which solidifies with the fixed image, and the rest may stay on the fuser roll surface. The wax layer on the image does not adversely affect image quality, and the liquefied wax layer on the fuser roll surface is usually cleaned off by the fuser cleaning web.

The formation of the wax stripping enhancing layer between the molten image and the fuser roll, particularly a polytetrafluoroethylene coated fuser roll, achieves excellent stripping performance. The advantages of low melt wax against high melt polypropylene wax include its large fusing latitude, excellent stripper mark performance, and manufacturability with the carnauba wax.

In order for the wax stripping enhancing layer to be formed during fusing, the fusing step is preferably conducted at a fuser set temperature between about 100° C. to about 210° C., preferably about 120° C. to about 210° C. Fusing is preferably conducted at a fuser nip temperature above the low melt wax melting point, the compatibilizer wax melting point and the toner binder glass transition temperature.

Embodiments will now be further illustrated by way of the following examples.

### EXAMPLES 1-5

The following example toner compositions were prepared.

TABLE 1

| | POLYWAX 850 | Carnauba Wax | Wax to | |
|---|---|---|---|---|
| | (wt. % | (wt. % | Carnauba | Stripping |
| Example | of toner) | of toner) | Wax Ratio | Performance |
| 1 | 3.0 | 2.0 | 1.5 | good |
| 2 | 3.0 | 0.5 | 6.0 | good |
| 3 | 1.0 | 2.0 | 0.5 | good |
| 4 | 1.0 | 0.5 | 2.0 | marginal |
| 5 | 2.0 | 1.4 | 1.4 | good |

Each of the above toner compositions was prepared as follows. The toner binder (DIACRON polyester resin), carbon black pigment, POLYWAX 850 and carnauba wax were melt-mixed together in a Werner and Pfleiderer ZSK-25 extruder. The operating conditions were a screw speed of 125 revolutions per minute, a feed rate of 10 pounds per hour, and a barrel temperature profile of zone I=120° C., zone 2=110° C., and zones 3 through 12=105° C. The amount of pigment was kept the same in each formulation, the amount of binder being adjusted to reach 100%. The mixture was then cooled and pulverized. The resulting melt mixed toner was pulverized using an ALPINE AFG-200 fluidized bed grinder. The resulting pulverized toner particles had a volume median of about 8.1 microns. The resulting toner particles were classified on an ACUCUT model B18 coupled classifier to achieve a final volume median of 8.5 microns+/−0.5 microns. The particles then had flow and charge enhancing additives dry blended onto them using a Henschel 10 L blender.

### COMPARATIVE EXAMPLE 1

A comparative toner was prepared in a similar manner to the Example 1-5 toners above. The toner included 1.8% by weight POLYWAX 550P (a polypropylene wax having a melting point of about 148° C.) and 0.9% carnauba wax instead of the low melt wax (e.g., POLYWAX 850) and carnauba wax of the Example toners.

The Example 1-5 and Comparative Example 1 toners were xerographically applied to Xerox Color Expressions (CX) and 4024 papers. These prints were then run through a fusing system having at least one stripper finger with dual stain gages, as described below, and the force required to strip each print from the fuser roll was measured.

As the fuser roll inside the fusing system used for running prints, a roll comprised of two coating layers is used. The first layer is a thick silicone layer on aluminum core and the second layer is a thin poly(tetrafluoroethylene-co-perfluroalkyl ether) coating having a loading of functional filler. The second layer is over-coated on the first silicone layer. As the pressure roll inside the fusing system used for running prints, layer construction is similar to that of the fuser roll except that it has a steel core, a thicker silicone coating, and a filled, electrically conductive poly(tetrafluoroethylene-co-perfluroalkyl ether) coating. The range fuser set temperature for stripping force testing was from about 170° C. to about 230° C. A typical nip pressure for testing was from about 0.35 MPa to about 0.83 MPa. A typical process speed for stripping test was from about 100 mm/s to about 1,000 mm/s.

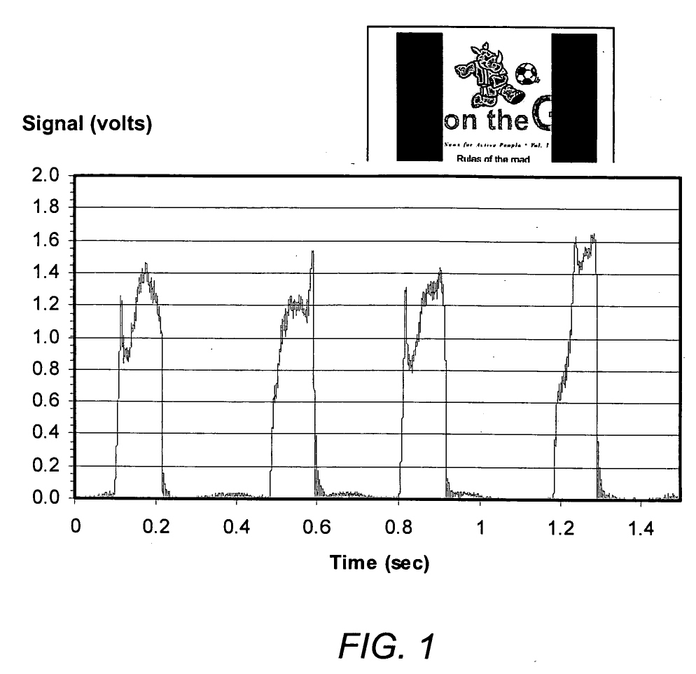

The main body of the stripper fingers used in the stripper finger assembly inside the fusing system used for running prints was 10 mm wide×25 mm long×0.15 mm thick steel sheet coated with low surface energy coating. The end of the finger contacting fuser roll surface is rounded with a radius of curvature of about 20 to about 40 mm so that a smooth contact on the fuser roll surface is ensured. As the stripper is loaded onto the fuser roll surface, the main body is bent such that the rounded end makes a contact of a fixed angle with the fuser roll surface. At least one of the stripper fingers is modified with two force sensors (Omega KFG-3-350-C1-11L1M2R strain gage) strongly adhered onto each side of the main body. The two force sensors are mounted in the exact opposite location of the main body. Two sensors are needed to minimize the effect due to temperature change and to maximize the signal due to a small amount of bending caused by the interaction of paper with the stripper finger. As the molten image adheres more strongly to the fuser roll surface, it is more difficult to separate the two surfaces, which causes the stripper finger to bend to a higher extent such that the force on the stripper finger tip can overcome the adhesive force between the molten image and fuser roll surface. In case that the image self-strips from the roll surface, the degree of stripper finger bending is not changed significantly because there is little or no force exerted by the exiting paper. The degree of bending is detected by the two force sensors giving rise to a differential signal in volts. The force (grams) can be determined by using the calibration curve of differential signal (volts), or referred to as signal (volts), versus known force. The signal-force calibration curve was found to be approximately linear in the stripping force systems designed for print testing. The signal or the force value can be recorded as a function of time as a print is passing through and interacting with the stripper fingers. From the signal-time plot, the maximum signal, thereby the maximum force can be determined. FIG. 1 shows the signal-time plot of two test prints from the Comparative Example 1 toner at a fusing temperature of 216° C., a process speed of 362 mm/s and a heating time on fixing of about 20 ms. It should be noted that there are two time zones of high signal for each print, which arise from the stripper finger running through two corresponding sticky solid area stripes. The data in FIG. 1 indicates that the maximum signal ranges from 1.4 volts to 1.6 volts, corresponding to maximum force from 129.1 grams to 148.9 grams. The maximum signal was measured for at least 5 prints, and an average value was determined, converted to a force value, which is referred to as the average maximum stripping force. For distinguishing stripping performance of toners comprising low-melt waxes and comparative toners, a relative force integral was also used by integrating the signal over a critical period of time of large signal. Both the relative force integral and the average maximum stripping force are excellent indicators for stripping performance. The higher the force integral (volt-sec) or the average maximum force (grams) is, the poorer the stripping performance.

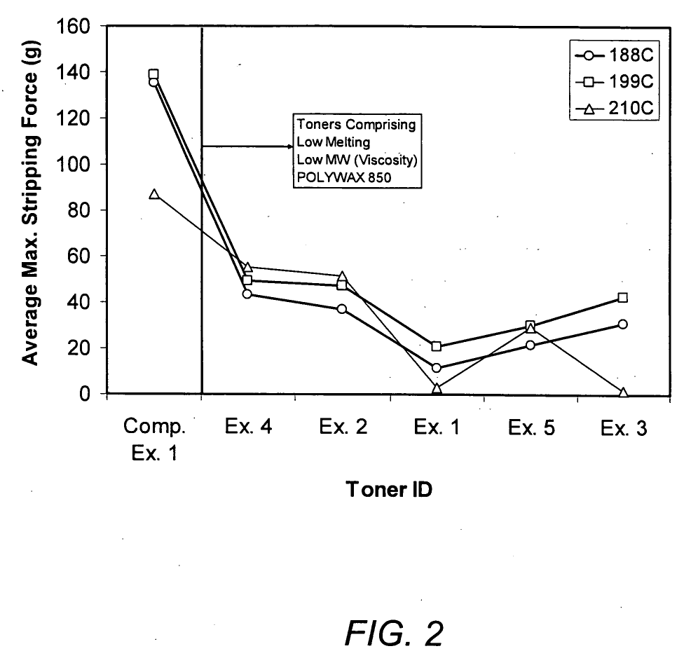

Stripping force data are shown in FIG. 2 for the low melt wax containing Example 1-5 toners and the Comparative Example 1 toner. Each toner was fused at three temperatures (188, 199 and 210° C.) on smooth CX and rough 4024 papers. All low melt wax containing toners exhibit much lower stripping force than the comparative example toner within the preferred fusing temperature window.

Table 2 summarizes the stripping force data for toners of Examples 1-5 and Comparative Example 1.

TABLE 2

| | POLYWAX | POLYWAX | Carnauba | | Stripping | Stripping |
|---|---|---|---|---|---|---|
| | 550P | 850 | Wax | | Force from | force from |
| | (polypropylene | (Weight % | (weight % of | Temperature | CX paper | 4024 paper |
| Example | wax) | of toner) | toner) | (° C.) | (grams) | (grams) |
| Comparative 1 | 1.8 | 0 | 0.9 | 188 | 135.4 | 104 |
| Comparative 1 | 1.8 | 0 | 0.9 | 199 | 138.9 | 119.4 |
| Comparative 1 | 1.8 | 0 | 0.9 | 210 | 87.2 | — |
| 4 | 0 | 1 | 0.5 | 188 | 43.5 | 23.6 |
| 4 | 0 | 1 | 0.5 | 199 | 49.4 | 24.1 |
| 4 | 0 | 1 | 0.5 | 210 | 55.2 | 34.3 |
| 2 | 0 | 3 | 0.5 | 188 | 36.9 | 31.8 |
| 2 | 0 | 3 | 0.5 | 199 | 47.2 | 39.5 |
| 2 | 0 | 3 | 0.5 | 210 | 51.7 | 4.2 |
| 5 | 0 | 2 | 1.4 | 188 | 21.7 | 14.1 |
| 5 | 0 | 2 | 1.4 | 199 | 30.2 | 17.9 |
| 5 | 0 | 2 | 1.4 | 210 | 29.3 | 4.2 |
| 3 | 0 | 1 | 2 | 188 | 30.9 | 15.4 |
| 3 | 0 | 1 | 2 | 199 | 42.6 | 17.2 |
| 3 | 0 | 1 | 2 | 210 | 1.6 | 1.2 |
| 1 | 0 | 3 | 2 | 188 | 11.6 | 7.4 |
| 1 | 0 | 3 | 2 | 199 | 20.8 | 2.4 |
| 1 | 0 | 3 | 2 | 210 | 2.8 | 2.2 |

The stripping performance of Comparative Example 1 toner exhibiting high stripping force values was poor, with the resulting print having significant stripper finger marks thereon. The low melt wax in toners of Examples 1-5 provides reduced stripping force from the fuser roll that is superior to that of the polypropylene wax of much higher melting point in toner of Comparative Example 1. The improvement of stripping is also enhanced as the amount of the wax is increased. The stripping force for the polypropylene wax is in the order of 80 to 140 grams compared to 40 grams or less, which may be enabled by the low melt wax at levels greater than 0.5%.

A desired level of stripping force required is 40 grams or less. In addition, with improved stripping performance, an increase in the paper handling and substrate latitude reliability is obtained through reductions in obstructions caused by stripping forces.

### EXAMPLES 6-11

Additionally, the following toner compositions (Table 3) were prepared using a different resin system.

TABLE 3

| | POLYWAX | POLYWAX | | |
|---|---|---|---|---|
| | 850 | 2000 | Carnauba Wax | Carbon black |
| | (weight % | (weight. % | (weight % of | (weight % of |
| Example | of toner) | of toner) | toner) | toner) |
| 6 | 3 | 0 | 2 | 5 |
| 7 | 3 | 0 | 4 | 5 |
| 8 | 1 | 0 | 4 | 5 |
| 9 | 2 | 0 | 3 | 5 |
| 10 | 1 | 0 | 2 | 5 |
| 11 | 0 | 2 | 3 | 5 |

Each of the above toner compositions was prepared as follows. The toner binder, a crosslinked polyester resin (such as described in U.S. Pat. No. 6,359,105), carbon black pigment, and the waxes were melt-mixed together in a Werner and Pfleiderer ZSK-25 extruder. The operating conditions were a screw speed of 135 revolutions per minute, a feed rate of 10 pounds per hour, and a barrel temperature profile of zone 1=120° C., zone 2 through zone 12=110° C. The amount of pigment was kept the same in each formulation, the amount of binder being adjusted to reach 100%. The mixture was then cooled and pulverized. The resulting melt mixed toner was pulverized using an ALPINE AFG-200 fluidized bed grinder. The resulting pulverized toner particles had a volume median of about 8.3 microns. The resulting toner particles were classified on an ACUCUT model B18 coupled classifier to achieve a final volume median of 9 microns+/−1.0 microns. The particles then had flow and charge enhancing additives dry blended onto them using a Henschel 10 L blender.

### COMPARATIVE EXAMPLE 2

A comparative toner was prepared in a similar manner to the Example 6-11 toners above. The toner was comprised of 87% by weight of a crosslinked polyester resin (U.S. Pat. No. 6,359,105), 5% by weight polypropylene wax having a Mw of about 660 and available as VISCOL 660P™ from Sanyo Chemicals of Japan, 5% by weight of REGAL 330™ carbon black, 3% by weight of a wax compatibilizer comprised of ethylene-glycidyl methacrylate copolymer AX-8840 available from Atofina Chemicals, Inc.

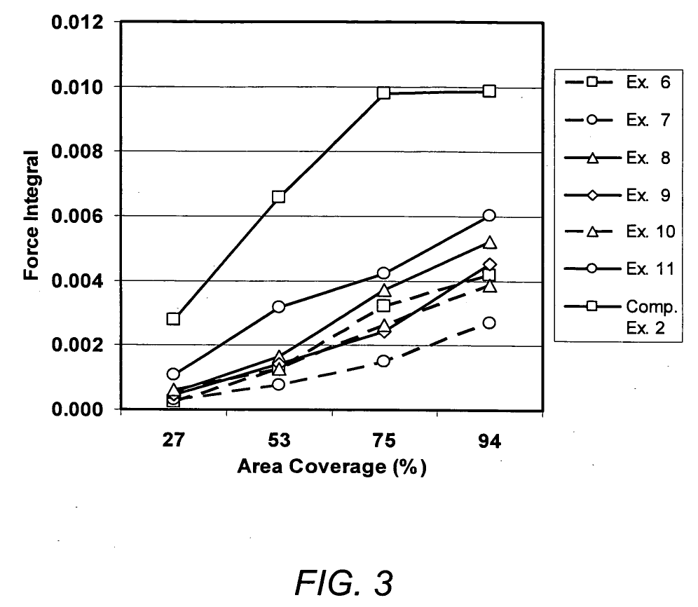

The Example 6-11 and Comparative Example 2 toners were xerographically applied to Xerox Color Expressions (CX) paper. These prints were run through a fusing system with a set temperature of 193° C. and a process speed of about 600 mm/s and with at least one stripper finger with dual strain gages, as described above, and the force required for stripping each print from the fuser roll versus time or print number was recorded. The calculated force integral (volt-sec) vs. area coverage (%) for the Example 6-11 and Comparative Example 2 toners is shown in FIG. 3. The term area coverage refers to the percentage of the paper surface (one side) that is covered with solid area image. As FIG. 3 shows, the carnauba/POLYWAX 850 toners have significantly lower force integrals and much superior stripping performance than the comparative toner.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A toner comprising at least one binder, at least one colorant, at least one wax having a melting point of 135° C. or less, and at least one compatibilizer wax.

2. The toner according to claim 1, wherein the at least one wax is a polyolefin wax.

3. The toner according to claim 1, wherein the at least one wax is a polyethylene wax.

4. The toner according to claim 3, wherein the polyethylene wax has a melting point of 110° C. or less.

5. The toner according to claim 1, wherein the at least one wax is present in an amount of from about 1 to about 8% by weight of the toner.

6. The toner according to claim 1, wherein the compatibilizer wax has a melting point of 135° C. or less.

7. The toner according to claim 1, wherein the compatibilizer wax is present in an amount of from about 0.5 to about 5% by weight of the toner.

8. The toner according to claim 1, wherein the at least one compatibilizer wax is carnauba wax.

9. The toner according to claim 8, wherein a ratio of the at least one wax to the carnauba wax ranges from about 1:2 to about 10:1.

10. The toner according to claim 1, wherein the at least one wax is a polyolefin wax present in an amount of from about 1 to about 8% by weight of the toner and the at least one compatibilizer wax is carnauba wax present in an amount of from about 0.5 to about 5% by weight of the wax.

11. The toner according to claim 1, wherein the at least one wax is a polyethylene wax present in an amount of from about 1 to about 8% by weight of the toner and the at least one compatibilizer wax is carnauba wax present in an amount of from about 0.5 to about 5% by weight of the wax.

12. The toner according to claim 1, wherein the toner has a volume average particle size of from about 2 to about 15 μm.

13. A developer comprising at least one carrier in admixture with a toner comprising at least one binder, at least one colorant, at least one wax having a melting point of 135° C. or less, and at least one compatibilizer wax.

14. An image forming process, comprising
depositing toner onto a latent image of an imaging member to form a toner image,
transferring the toner image to an image receiving substrate, and
fusing the toner image,
wherein the toner comprises at least one binder, at least one colorant, at least one wax having a melting point of 135° C. or less, and at least one compatibilizer wax, and
wherein the at least one wax and the at least one compatibilizer wax exude from the toner during the fusing, forming a stripping enhancing layer upon the toner image.

15. The image forming process according to claim 14, wherein the fusing is conducted at a temperature of from about 100° C. to about 210° C.

16. The image forming process according to claim 14, wherein substantially all of the toner image is covered by the stripping enhancing layer.

17. The image forming process according to claim 14, wherein the fusing is conducted with a fuser roll having a polytetrafluoroethylene coating thereon.

18. The image forming process according to claim 14, wherein the fusing is conducted with a fuser roll having a polytetrafluoroethylene coating upon a silicone.

19. The image forming process according to claim 14, wherein the at least one wax is a polyolefin wax present in an amount of from about 1 to about 8% by weight of the toner and the at least one compatibilizer wax is carnauba wax present in an amount of from about 0.5 to about 5% by weight of the wax.

20. An image forming device for conducting the image forming process of claim 14.
